(19) United States
(12) Patent Application Publication
(10) Pub. No.: US 2026/0038468 A1
(43) Pub. Date: Feb. 5, 2026

(54) Expressive Note and Chord Detection and Evaluation

(71) Applicant: Daniel James Blackburn, Ile Perrot (CA)

(72) Inventor: Daniel James Blackburn, Ile Perrot (CA)

(21) Appl. No.: 18/792,430

(22) Filed: Aug. 1, 2024

(51) Int. Cl. G10H 1/00

(52) U.S. Cl. CPC G10H 1/0008; G10H 2210/051; G10H 2220/116; G10H 2220/126; G10H 2240/056

(57) ABSTRACT

Methods and systems for the expressive and dynamic detection and evaluation of notes and chords in digital music production software are disclosed. In one embodiment, the method comprises a series of modules designed to extract and group notes into combinations based on several adjustable and scalable parameters. Furthermore, the method comprises the automatic integration of modulation curve data into the resulting groupings of notes, which can be achieved either through manual assistance or through the application of a predictive model.

### TECHNICAL FIELD

This invention relates to digital music production systems and in particular to detecting and evaluating music note data in an expressive and dynamic manner.

### BACKGROUND ART

Modern digital music production systems provide composers, producers, and music developers with significant flexibility in the way they write music. Notes can start and stop at any point in time and can have any desired length, allowing for a fluid and dynamic composition process. This results in the ability to create complex layers of overlapping notes that diverge from the traditional standards of note and chord writing.

In traditional sheet music programs, a single prolonged chord is typically understood as a continuous harmonic entity. However, in modern music production, this interpretation can be vastly more complex and nuanced. In digital music production systems, what appears to be a single extended chord might actually be treated as multiple distinct chords. The duration, positioning, and the note changes within the chord can signify different harmonic intentions by the composer. For example, a prolonged grouping of notes might gradually evolve in its harmonic content, shifting from one chord to another through subtle changes in note distribution, voicing, or the addition and subtraction of certain notes over time. Thus, in a digital music production system, a prolonged grouping of notes is not merely a static harmonic block but a dynamic, evolving structure.

Existing note and chord detection systems allow for the identification of discrete musical events, such as clearly defined and separated notes and chords. However, existing systems do not provide any way of detecting the subtle transformations of harmonic content within a group of notes. This limitation means that accurate representations of modern digital compositions may be missed or oversimplified by existing detection systems, and significantly restricts the ability to automate certain subsequent user processes that would otherwise enhance the user experience. As a result, users will waste valuable time performing these processes manually, which detracts from the creative process and causes frustration due to the need to repeatedly execute the same manual tasks.

### BRIEF SUMMARY OF THE INVENTION

Provided are various mechanisms and processes for optimizing a note and chord detection and evaluation system. These mechanisms and processes analyze the temporal relationships of notes and their overlaps with one another. In one embodiment, the note and chord detection and evaluation system employs a mechanism, herein called the combination module, to initially group notes together and identify baseline note relationships. These baseline groupings are subsequently re-evaluated using another mechanism, herein called the separation module, to further discern the subtle harmonic changes intended by the composer. This provides the ability to detect and modify complex note and chord phrases without relying on discrete note separations and further enables programs to dynamically process intricate musical segments, facilitating a range of subsequent tasks.

The note and chord detection and evaluation system also allows users to add modulation curve data to each detection, either through manual assistance or automatically. In one embodiment, the system can predict the optimal modulation curve for each detected note or chord based on users' past behavior when creating modulation curves. This is achieved through a machine-learned predictive model, referred to as the curve generation model, which predicts the most suitable modulation curve. Both approaches significantly accelerate and streamline the original task, offering a high level of customization compared to the manual drawing of modulation curves by users for their composed notes and chords.

The features and advantages described in this summary and the following detailed description are not all inclusive. Many additional features and advantages will be apparent to one of ordinary skill in the art in view of the drawings, specification, and claims.

### BRIEF DESCRIPTION OF THE DRAWINGS

FIG. 1 is a system diagram of the note and chord detection and evaluation system, in accordance with an embodiment of the invention.

FIG. 2 is a block diagram illustrating the different modules inside the Note and Chord Detection and Evaluation system, in accordance with an embodiment of the invention.

FIG. 3 is an illustration of the class diagram of the Note and Chord Detection and Evaluation System, in accordance with an embodiment of the invention.

FIG. 4 is a flowchart of an exemplary method for extracting musical note information, in accordance with one embodiment of the invention.

FIG. 5 is a flowchart of an exemplary method for determining whether to group notes into combined note events, in accordance with one embodiment of the invention.

FIG. 6 is a flowchart of an exemplary method for detecting whether or not to split, cut, or create additional combined note events, in accordance with one embodiment of the invention.

FIG. 7 is a flowchart of an exemplary method for enhancing a combined note event with modulation curve data using the Curve Generation model, in accordance with one embodiment of the invention.

FIG. 8A is an exemplary user interface for enhancing combined note events in a Note and Chord Detection and Evaluation system, in accordance with one embodiment of the invention.

FIG. 8B is another exemplary user interface for combined note event enhancement, using a machine learned model, in accordance with one embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### System Overview

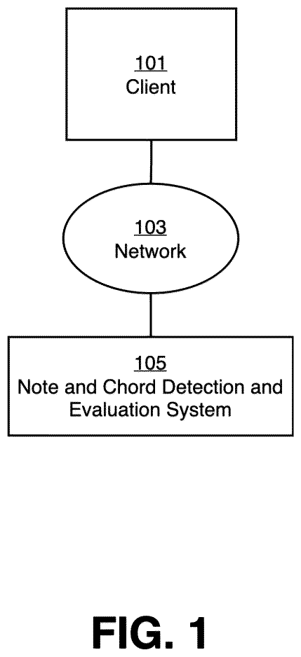

Referring now to FIG. 1, there is shown the system architecture adapted to support one embodiment of the present invention. In one embodiment, the system architecture operates as a standalone application. However, the system architecture can also be integrated within a Digital Audio Workstation (DAW) or any other relevant music production software. The network 103 represents the communication pathways between the client 101 and the note and chord detection and evaluation system 105. The network uses standard communications technologies and/or protocols. The client device 101 is used to provide music data to the note and chord detection and evaluation system 105. In the context of this application, “music data” is understood to be any information that includes, but is not limited to, note on/off data, note duration, note pitch, note velocity, musical key, tempo, time signature, articulation, dynamics, and the like.

There can be several types of clients 101 that use the note and chord detection and evaluation system 105. In some embodiments, the client can be the system itself, such as in cases where the stand-alone application or DAW needs to automatically perform or is scheduled to perform tasks that need to detect and process notes and chords from various music data. In other embodiments, the client can be the user of the application, and may interact with and provide music data to the note and chord detection and evaluation system 105. The note and chord detection and evaluation system 105 comprises additional components and modules that are described below.

### Note and Chord Detection and Evaluation System

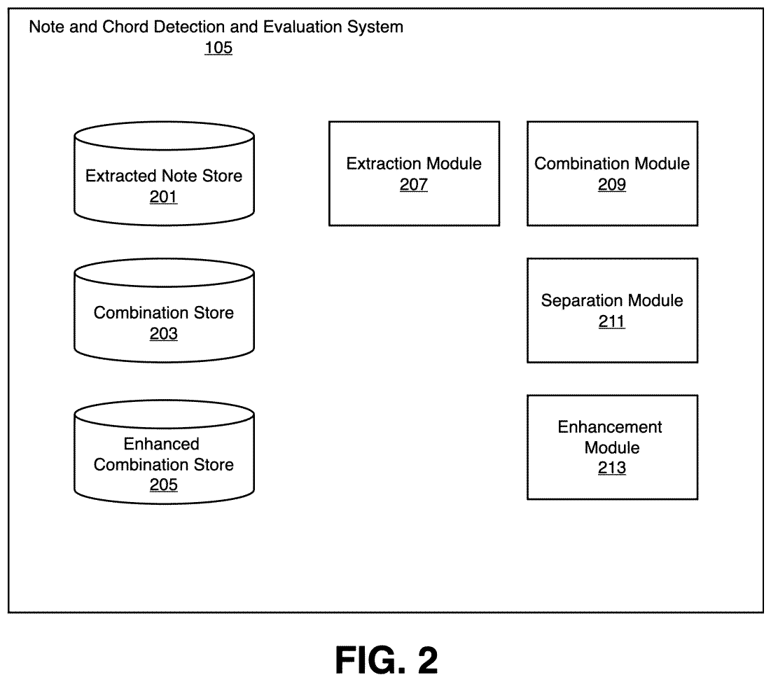

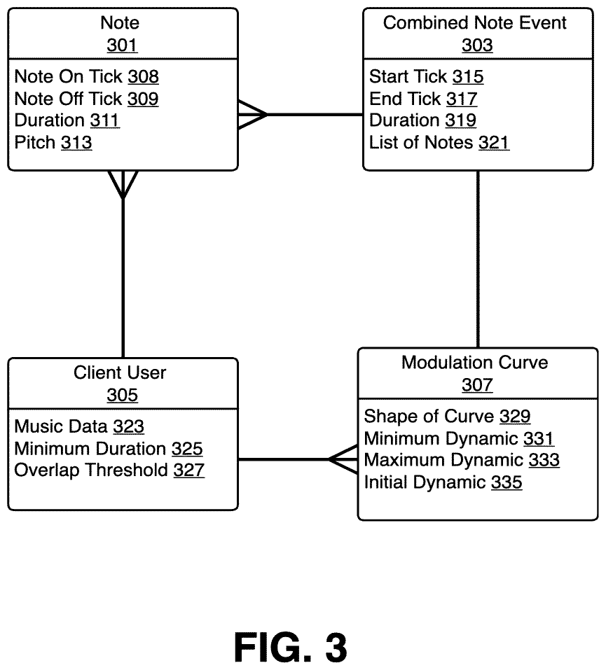

Referring to FIG. 2 and FIG. 3, in one embodiment the Note and Chord Detection and Evaluation System 105 comprises an extracted note store 201, a combination store 203, an enhanced combination store 205, an extraction module 207, a combination module 209, a separation module 211, and an enhancement module 213. Those of skill in the art will appreciate that the note and chord detection and evaluation system 105 may contain other modules that are not described herein. In addition, conventional elements, such as audio and MIDI processors, plugin support, external device handling, load management, and so forth are not shown as they are not material to the invention. The system 105 may be implemented using a single computer, or a network of computers, including cloud-based computer implementations. The operations of the system 105 as described herein can be controlled through either hardware or through computer programs installed in non-transitory computer storage and executed by the processors to perform the functions described herein. The various stores (e.g., extracted note store 201, combination store 203, etc.) are implemented using non-transitory computer-readable storage devices, and suitable database management systems for quick data access and retrieval. The system 105 includes other hardware elements necessary for the operations described here, including input devices for data entry, and output devices for display, printing, or other presentations of data.

The extraction module 207 takes a client 101 provided music data 323 as input and parses it in order to extract note data, and is one means for performing this function. Each note is represented by note object 301, which may also be called a note profile. Information about notes includes note on tick 308, note off tick 309, duration 311, and pitch 313. Both the note on and off ticks provide a numerical temporal location of where the note starts and stops, respectively, and can be relative to the other notes present in the music data 323. The duration 311 can be thought of the length of the note, and may be derived by subtracting the note on tick 308 from the note off tick 309. The extraction module 207 searches through the music data 323, ignoring any elements that are not part of each note's note profile 301. The extracted note store 201 stores all the note profiles provided via the extraction module 207 and is one means for performing this function. Each entry in the extracted note store 201 is associated with a distinct note profile 301.

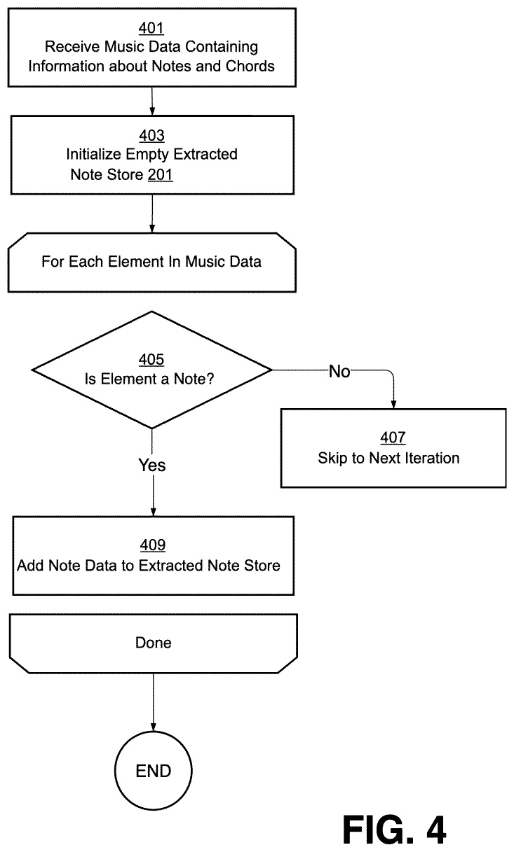

FIG. 4 shows a flowchart of a process for extracting musical note information for the note and chord detection and evaluation system 105, in accordance with one embodiment of the invention. The extraction module 207 receives 401 music data containing information about notes and the like. The extraction module 207 then initializes 403 a new instance of the extracted note store 201. For each note detected 405, the extraction module 207 adds 409 the appropriate note profile 301 as an entry in the extracted note store 201, skipping 407 any data that is not part of the note profiles.

The combination module 209 receives the entries inside the extracted note store 201 and returns a list of combined note events 303. In the context of this invention, a “combined note event” is understood to be a grouping of note objects 301. In some embodiments, these groupings, or combined note events, may consist of a collection of notes 321 each with their own note profiles 301, an overall start tick 315, an overall end tick 317, an overall duration 319, and may include intervals of silence, as per the musical term. The criteria for grouping notes into combined note events 303 are directed and modifiable through the client and its associated client user object 305 parameters: minimum duration 325, and overlap threshold 327. The minimum duration 325 specifies the shortest length that a combined note event must meet or exceed. In some embodiments, minimum duration can be a numerical value, similarly to the numerical values of note on tick 308 and note off tick 309. In other embodiments, minimum duration 325 can be set to a musical note value, maintaining consistency relative to any tempo changes within the musical data 323. For example, setting a minimum duration to an eighth note requires that all combined note events 303 have a duration equal to or greater than an eighth note, regardless of the tempo. The overlap threshold 327 applies when a combined note event 303 overlaps with the next note entry to be processed from the extracted note store 201. Overlapping occurs when the end tick of a combined note event is greater than the start tick of a subsequent note. The threshold delineates the time span from the commencement of a combined note event 303 within which a subsequent note must begin to be included in the same combined note event 303. Similarly, the overlap threshold 327 can be set to a numerical value, or can be set to a musical note value. For example, if the overlap threshold is set to an eighth note, then any subsequent note that overlaps and commences within an eighth note of time from the beginning of a combined note event 303 will be grouped together by the combination module 209 and form an updated combined note event. Both the minimum duration 325 and overlap threshold 327 parameters are scalable and provide flexibility and precision in determining the structure of combined note events, allowing much more accurate musical note groupings. The combination store 203 stores all the combined note event data provided by the combination module 209 and is one means for performing this function. Each entry in the combination store 203 corresponds to a distinct combined note event 303.

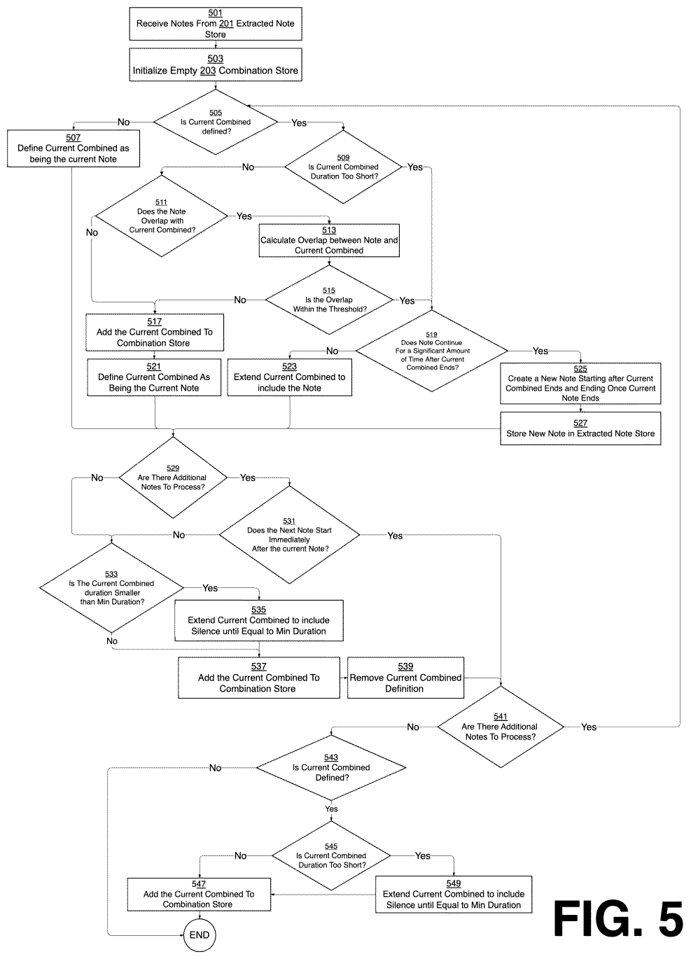

FIG. 5 illustrates a flowchart detailing the process for determining whether to group note objects 301 into combined note events, in accordance with one embodiment of the invention. The use of the term “current combined” in the flowchart refers to the most recent combined note event 303 that has been created but not yet added to the combination store 203. This may be because its length is currently less than the specified minimum duration 325 or because there are additional notes in the extracted note store 201 that could still be grouped into it. Furthermore, the term “a significant amount of time” as used in the flowchart typically refers to a period exceeding the minimum duration. However, the exact length is a design choice left to the system administrator's discretion. In one embodiment, “a significant amount of time” is defined as any duration longer than twice the minimum duration. The process begins by receiving notes 501 from the extracted note store 201 and initializing 503 an empty combination store 203. The order in which notes are processed is determined by their note on tick 308 values, arranged from smallest to largest. First, the system checks 505 if a current combined event has been defined. If not, the current note being processed is defined 507 as the current combined event. If a current combined event is already defined, the system then checks 509 if the duration of the current combined event is smaller than the minimum duration. If the duration is sufficient, the system then checks 511 if the current note overlaps with the current combined event. If there is no overlap, the current combined event is added 517 to the combination store and the current note is defined 521 as the new current combined event.

If the current note being processed does overlap, the system calculates 513 the overlap between the note and the current combined event. If the duration of the current combined event is too short or if 515 the overlap is within the overlap threshold, the system checks 519 if the note continues significantly after the current combined event ends. If the overlap is not within the threshold, the current combined event is added 517 to the combination store and the current note being processed is defined 521 as the new current combined event. If the note does not continue significantly after the current combined event ends, the current combined event is extended 523 to include the current note, because the proximity suggests that they should be harmonically grouped together. If the note does continue significantly, a copy of the current note is created 525, but starting after the current combined event ends and ending once the current note ends, and this new note is stored 527 in the extracted note store to be processed in the following iterations.

The system then checks 529 if there are additional notes to process. If there are, it checks 531 if the next note starts immediately after the current note being processed. If either decision 529 or 531 is negative, the system checks 533 if the current combined event's duration is smaller than the minimum required duration. If it is, the current combined event is extended 535 to include silence until it meets the minimum duration, then added 537 to the combination store, and the current combined event definition is removed 539. If the current combined event's duration is already sufficient, the system adds 537 it to the combination store and removes 539 the current combined event definition. If 531 the next note starts immediately after the current note, the system proceeds without doing any of these steps.

The system now again checks 541 if there are additional notes to process. If there are, the system returns to decision 505 and processes the following note entry in the extracted note store 201. If there are no more notes, it checks 543 if the current combined event is defined. If not defined, the process ends here. If it is defined, the system checks 545 if its duration is smaller than the minimum required duration. If the duration is sufficient, the current combined event is added 547 to the combination store. If the duration is too short, it is extended 549 to include silence until it meets the minimum duration, and finally added 547 to the store. The process ends once all combined note events have been constructed and appropriately stored.

The separation module 211 processes the entries within the combination store 203 to ensure that each entry does not overlap with any other. Up to this point, notes from the extracted note store 201 have been grouped into combined note events 303 by the combination module 209 based on their temporal relationships. However, this grouping may result in overlapping combined note events. Overlapping combined note events are undesirable, as they cause issues during subsequent operations and are not representative of the harmonic relationships in the provided musical data structure. Therefore, the separation module 211 resolves these overlaps as necessary, and updates each entry in the combination store 203 with clear and distinct combined note events.

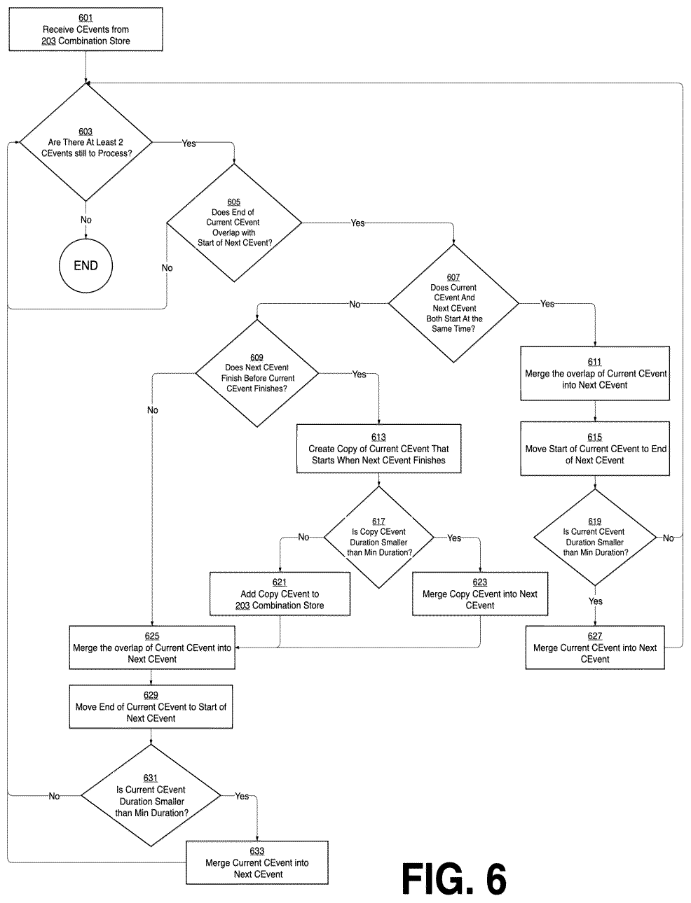

FIG. 6 illustrates a flowchart detailing the process for determining whether to split, cut, or create additional combined note events, in accordance with one embodiment of the invention. In this flowchart, the label “CEvent” is an abbreviation for a combined note event. Likewise, “Current CEvent” and “Next CEvent” refer to the current combined note event entry and the subsequent combined note event entry to be processed from the combination store 203, respectively. Furthermore, the action to “merge” two combined note events means to merge both collected data into a single combined note event. The process begins by receiving 601 combined note events (CEvents) from the combination store 203. Similarly to the combination module, The order in which combined note events are processed is determined by their start tick 315 values, arranged from smallest to largest. It then checks 603 if there are at least two CEvents still to process. If not, the process ends. If there are, it checks 605 if the end of the current CEvent overlaps with the start of the next CEvent. If no overlap is detected, the process returns to step 603 for the next iteration. If they do overlap, the system checks 607 if both the current and next CEvents start at the same time. If they do, the process merges 611 the entire overlapping portion of the current CEvent into the next CEvent, and then moves 615 the start of the current CEvent to the end of the next CEvent. Subsequently, it checks 619 if the new duration of the current CEvent is smaller than the minimum duration. If it is too short, the current CEvent is merged 627 into the next CEvent, and the process returns to step 603 for the next iteration. If the duration is sufficient, the process also returns to step 603 for the next iteration.

If decision 607 is negative, the system then checks 609 if the next CEvent finishes before the current CEvent. If it does, a copy of the current CEvent is created 613 but starting when the next CEvent finishes. The system then checks 617 if the duration of the copied CEvent is smaller than the minimum duration. If the copied CEvent duration is sufficient, it is added 621 to the combination store 203. If the duration is too short, the copied CEvent is merged 623 into the next CEvent. If 609 the next CEvent does not finish before the current CEvent, these steps are skipped.
The process then merges 625 the entire overlapping portion of the current CEvent into the next CEvent and moves 629 the end of the current CEvent to the start of the next CEvent. It then checks 631 if the current CEvent duration is now smaller than the minimum duration. If the duration is sufficient, the process returns to step 603 for the next iteration. If it is too short, the current CEvent is merged 633 into the next CEvent. The system then returns to step 603 for the next iteration. This process repeats until all remaining CEvents, including those created during the operation, have been processed and appropriately stored.

Once the separation module 211 completes its task, those skilled in the art will recognize that each final combined note event entry can represent a wide array of musical data. For instance, a combined note event can encompass anything from a single note to complete harmonies, and may also include silences where appropriate. This versatility and accuracy in detection facilitate the application and automation of numerous subsequent processes and enhancements to the notes.

In certain embodiments of the invention, an additional enhancement module 213 may be integrated into the note and chord detection and evaluation system 105. The enhancement module 213 processes the finalized combined note event entries from the combination store 203 and can perform various creative modifications on these entries, and is one means for performing this function. As will be described from here on, of particular interest and novelty is the automatic application of modulation curves to combined note events originating from or being converted to a MIDI file data format. The enhancement module assigns a modulation curve object 307 to each combined note event object 303. Each modulation curve 307 contains detailed information, including the shape of the curve 329, the minimum dynamic 331, and the maximum dynamic 333. The shape of the curve 329 can take various forms, such as linear, sinusoidal, exponential, among others. Within the context of a MIDI file data format, the minimum 331 and maximum 333 dynamic values can range from 0 to 127, representing dynamics from very soft to very loud, respectively. Alternatively, a range of musical dynamic labels, from ppp, pp, p, mp, mf, f, ff, to fff, can serve as substitutes for the numeric range of 0 to 127, or can be defined based on the design preferences of the system administrator. The enhanced combination store 205 then stores all the combined note event data along with their associated modulation curves provided by the enhancement module 213 and is one means for performing this function. In one embodiment, the user is presented an interface that allows them to manually select each modulation curve 307 parameters for each detected combined note event.

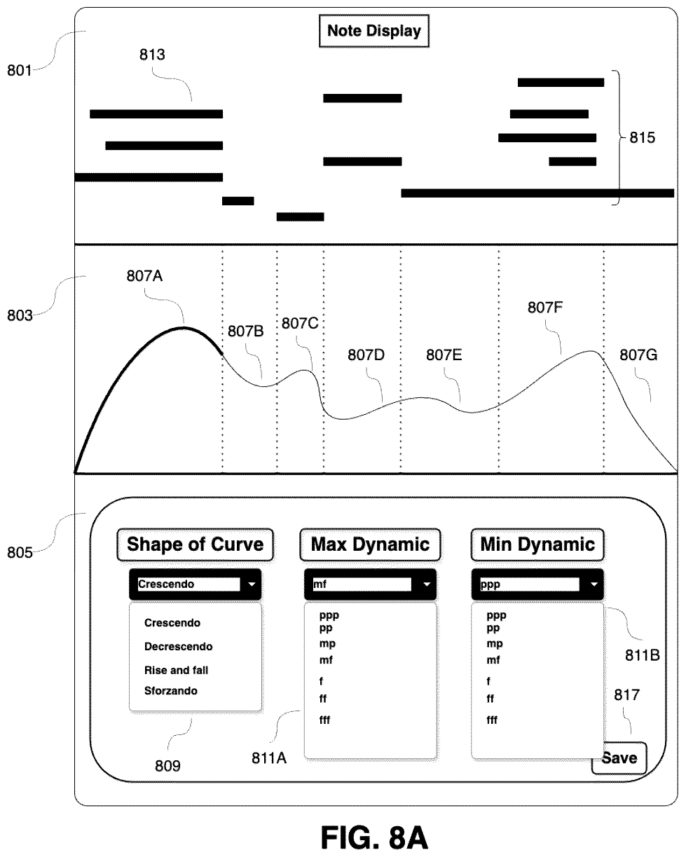

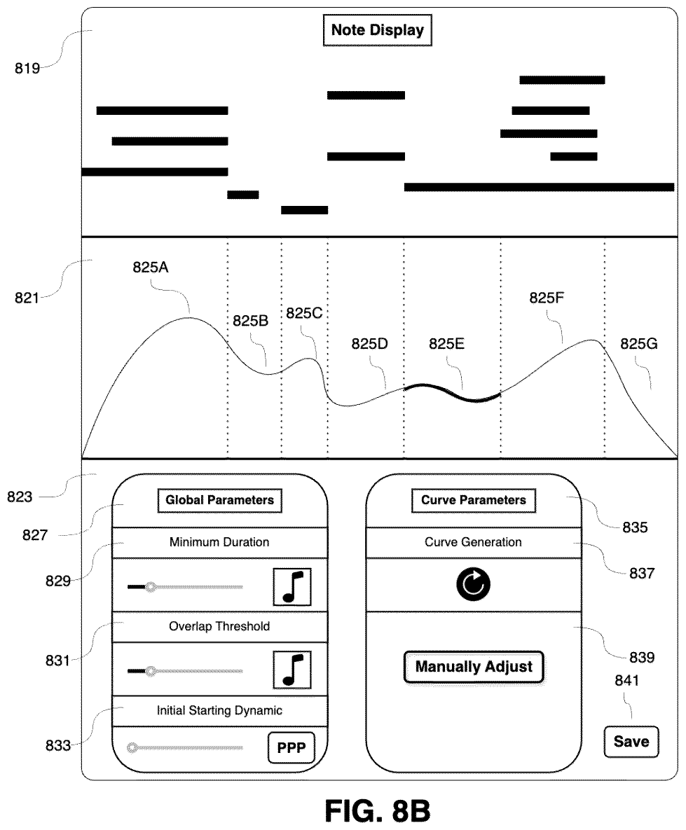

FIG. 8A shows an exemplary embodiment of the user interface for a user to manually enhance the combined note events provided by the separation module 211 with modulation curve data. The example user interface consists of three main components: a note display 801, a modulation curve display 803, and a parameter input section 805. Within the note display 801, individual notes 813 are visually represented by horizontal bars. Each bar's vertical position corresponds to the note's pitch, while its length indicates the note's duration. An example of a detected combined note event 815 is shown, and all other combined note events can be determined by the dotted vertical separators in section 803. The middle section 803 of the diagram is dedicated to displaying modulation curves that are applied to the combined note events. In the example diagram, multiple curves 807A, 807B, 807C, 807D, 807E, 807F, and 807G are depicted. The first curve 807A is highlighted in bold, indicating that it is currently selected for editing. This visual distinction helps users easily identify the curve being modified. Furthermore, users have the ability to click and drag any point on the selected curve to make adjustments as desired. The bottom section 805 is designed for user input of parameters specific to the selected modulation curve. The first drop-down menu 809 enables users to select the shape of the curve 329 from example options such as crescendo, decrescendo, rise and fall, sforzando, among others. These options can represent musical terms for linear, sinusoidal, exponential, or other types curves with their specific mathematical functions being a design choice determined by the system administrator. The second drop-down menu 811A enables the selection of the maximum dynamic 333 level, with choices ranging from ppp to fff. The third drop-down menu 811B provides options for the minimum dynamic 331 level, also with a range from ppp to fff. The interface allows users to click on any of the curves displayed in part 803. Upon selection, the parameters for that curve are loaded and displayed in the parameter input section 805. This interactive feature enables users to efficiently switch between different curves and adjust their settings as needed. Once the user is satisfied with their choices, they can click the save button 817, which will write the modulation data into a MIDI file containing the notes and also store the relevant data into the enhanced combination store 205.

### Curve Generation Model

Some embodiments of the enhancement module 213 employ a machine learned, predictive model, referred to as the curve generation model, to automatically generate optimal modulation curves. In one embodiment, a supervised machine learning algorithm, such as Long Short-Term Memory (LSTM), is used to construct the predictive model. In other embodiments, other machine learning algorithms, such as Recurrent Neural Networks (RNNs), Transformer models, or any other sequence generation algorithm may be used to build the predictive model.

In one embodiment, the module 213 creates a model for individual combined note events, enabling the system to capture the specific musical behaviour of a combined note event. In other embodiments, the module 213 can generate a phrase-specific model to encapsulate the musical behaviour of entire phrases. Phrase-specific models are particularly useful for reflecting the dynamic interplay between various combined note events within a musical phrase. Conversely, combined note event-specific models can serve as a default model when there is insufficient historical data with which to create a phrase-specific model. The curve generation model learns to generate a sequence of numerical modulation values (the modulation curve) that aligns well with a given input data.

The curve generation model is trained on a set of training data extracted from past combined note events 303 and their associated modulation curves 307 generated and approved by client users 305 over some time period. The time period can cover all historical curves, or only a limited period of time (e.g., the past six months). For a combined note event-specific model, the training set is all modulation curves and their associated combined note events. First, the information contained within each combined note event is collected, referred to as the features of the predictive model. This includes the note profiles 301 present within each combined note event. Included in the information collected is the initial dynamic 335 for each modulation curve, which corresponds to the very first value of the curve. During the training period, the model learns to map the input features to the corresponding modulation curves. These curves are processed into sequences of dynamic values that represent the modulation of the combined note event over time. This learning process intends to minimize the difference between the model's predicted modulation curves and the actual user-approved curves.

When a client uses the combined note event-specific model to generate a sequence of modulation curves for each combined note event in a musical phrase, the initial dynamic 335 for the first modulation curve that begins the phrase can be set to zero. For all subsequent curves, the initial dynamic corresponds to the final value of the previous curve. Capturing the initial dynamic 335 is important as it influences the direction of the beginning of the curve. For example, an initial dynamic value close to the maximum possible value suggests that the modulation curve is less likely to initially continue in an upward direction. Conversely, a low initial dynamic value indicates a similar constraint in the downward direction.

For a phrase-specific model, the training set comprises musical phrases consisting of combined note events and their associated modulation curve spanning the entire phrase. Similarly, information for each combined note event is collected as input features for the model. During the training period, the model learns to map this multitude of input features to the continuous modulation curve for the entire phrase. The learning process is intended to minimize the difference between the model's predicted modulation curves and the actual user-approved curves.

Embodiments of the curve generation model can also be tailored to different instrument types based on their modulation curves. For example, the curve generation model can determine that every musical phrase played by the flute should have certain characteristics in their generated modulation curves based on similar patterns in their modulation curves of the past. Similarly, a curve generation model can be built for the brass instruments based on all the previous modulation curves for brass instruments.

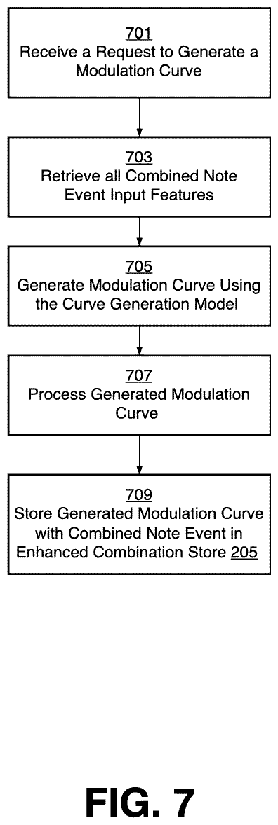

FIG. 7 is a flowchart of a process for automatically generating modulation curves, in accordance with an embodiment of the invention. The process begins by receiving 701 a request to generate a modulation curve. The system then retrieves 703 all necessary and relevant combined note event input features associated with the modulation curve. Utilizing these input features, it generates 705 a modulation curve using the curve generation model. The generated modulation curve can then be processed 707, allowing for further modification and adjustment to the client's preferences, although no modification is also an option. Finally, the system stores 709 the generated modulation curve with the combined note event as an entry in the enhanced combination store 205.

The curve generation model beneficially allows the enhancement module to select and present the modulation curve with the highest predicted satisfaction to the user/client. This spares users who may not be proficient in creating their desired curves from repeated, frustrating trial and error, thereby preserving their creative process. Additionally, this approach prevents overwhelming the user with excessive choices and reduces the time spent modifying the curves.

FIG. 8B shows an exemplary embodiment of a user interface for automatically enhancing combined note event data with modulation curves, using the curve generation model. The exemplary user interface comprises three main components: a note display 819, a modulation curve display 821, and a parameter input section 823. The note display 819 and modulation curve display 821 are identical to their respective counterparts in FIG. 8A. In the example diagram, multiple curves 825A, 825B, 825C, 825D, 825E, 825F, and 825G are depicted, and the curve 825E is highlighted in bold, indicating it is currently selected for editing. The bottom section 823 differs from FIG. 8A and introduces functionalities using the curve generation model. This section is divided into two main parts: global parameters 827 and curve parameters 835. The global parameters 827 subsection allows users to quickly set and modify the general parameters affecting how combined note events are detected. Adjusting the minimum duration slider 829 or the overlap threshold slider 831 prompts the program to restart its detection process using the new parameter values. This adjustment will be visible as the vertical dotted lines in section 821 shift left or right. The initial starting dynamic slider 833 enables the user to specify the dynamic level at which the first curve 825A should begin. The curve parameters 835 subsection focuses on parameters specific to the selected curve. The curve generation refresh button 837 prompts the program to re-generate a modulation curve for its associated combined note event, providing the user with an updated selection in case they are not satisfied with the current modulation curve presented. A button labeled “Manually Adjust” 839 lets the user temporarily change the parameter input section 823 to the same layout as section 805 in FIG. 8A, facilitating more precise manual adjustments. Once the user is satisfied with their choices, they can click the save button 841, which will write the modulation data into a MIDI file containing the notes and also store the relevant data into the enhanced combination store 205.

### Alternative Applications

The features and benefits outlined in the specification are not exhaustive. Numerous additional features and advantages will be evident to those skilled in the art when considering the drawings, specification, and claims. Furthermore, it is important to note that the language used in the specification is primarily chosen for readability and instructional purposes, and may not have been selected to delineate or circumscribe the inventive subject matter.

The above description of the embodiments of the invention is provided for illustrative purposes. It is not meant to be exhaustive or to restrict the invention to the exact forms disclosed. Those skilled in the relevant art will recognize that numerous modifications and variations are possible based on the information provided.

Certain sections of this description present the embodiments of the invention through algorithms and symbolic representations of operations on information. These algorithmic descriptions and representations are commonly used by those skilled in data processing to effectively communicate their work to others in the field. While these operations are described in functional, computational, or logical terms, they are understood to be implemented through computer programs, equivalent electrical circuits, microcode, or similar means. Furthermore, it is sometimes convenient to refer to these sets of operations as modules, without any loss of generality. The described operations and their associated modules can be implemented in software, firmware, hardware, or any combination thereof.

Any of the steps, operations, or processes described here can be executed or implemented using one or more hardware or software modules, either individually or in combination with other devices. In one embodiment, a software module is realized with a computer program product that includes a computer-readable medium containing computer program code. This code can be executed by a computer processor to perform any or all of the described steps, operations, or processes.

Embodiments of the invention may also pertain to an apparatus designed to perform the operations described herein. This apparatus can be specifically built for the intended purposes or may consist of a general-purpose computing device that is selectively activated or reconfigured by a computer program stored within it. Such a computer program can be stored on a tangible computer-readable storage medium or any suitable media for holding electronic instructions, and connected to a computer system bus. Additionally, any computing systems mentioned in the specification may feature a single processor or may utilize multiple processor architectures to enhance computing capability.

Lastly, the language used in the specification has been chosen primarily for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer implemented method, comprising:
extracting musical note data from a data format via an extraction module, wherein the data format includes one or more of the following types of information: note on, note off, pitch, control change, program change, pitch bend, aftertouch, track data, MIDI data, automation data, grid data, time signature, and key signature;
grouping the extracted notes together based on temporal relationships and musical appropriateness criteria;
detecting any overlapping between the different grouped notes;
splitting and merging the grouped notes based on temporal relationships between the groupings.

2. The computer implemented method of claim 1, wherein the data format to be extracted is a MIDI file.

3. The computer implemented method of claim 1, wherein the temporal relationships and musical appropriateness criteria used are modifiable by the client.

4. The computer implemented method of claim 1, wherein the groupings of notes may contain periods of silence, as per the musical term.

5. The computer implemented method of claim 1, further comprising, for each grouping of notes, adding modulation curve data.

6. The method of claim 5, further comprising providing a user interface to the client comprising a set of parameters for manually adding modulation curve data to each grouping of notes.

7. The method of claim 5, further comprising:
identifying a plurality of past created modulation curves made by clients for groupings of notes;
training a predictive computer model based on values of the plurality of features of the past created modulation curves and groupings of notes;
generating a modulation curve, by applying the predictive computer model to a grouping of notes, that is predicted to best complement that grouping of notes and satisfy the client;
providing a user interface to the client comprising, for each grouping of notes, a generated modulation curve, and a set of parameters for manual adjustments to the modulation curve data.

8. A system comprising:
a non-transitory computer-readable medium with instructions encoded
thereon; and
one or more processors configured to, when executing the instructions, perform operations of:
extracting musical note data from a data format via an extraction module, wherein the data format includes one or more of the following types of information: note on, note off, pitch, control change, program change, pitch bend, aftertouch, track data, MIDI data, automation data, grid data, time signature, and key signature;
grouping the extracted notes together based on temporal relationships and musical appropriateness criteria;
detecting any overlapping between the different grouped notes;
splitting and merging the grouped notes based on temporal relationships between the groupings.

9. The system of claim 8, wherein the data format to be extracted is a MIDI file.

10. The system of claim 8, wherein the temporal relationships and musical appropriateness criteria used are modifiable by the client.

11. The system of claim 8, wherein the groupings of notes may contain periods of silence, as per the musical term.

12. The system of claim 8, wherein the one or more processors is further configured, when executing the instructions, to perform operations of adding modulation curve data to each grouping of notes.

13. The system of claim 12, wherein the one or more processors is further configured, when executing the instructions, to perform operations of providing a user interface to the client comprising a set of parameters for manually adding modulation curve data to each grouping of notes.

14. The system of claim 12, wherein the one or more processors is further configured, when executing the instructions, to perform operations of:
identifying a plurality of past created modulation curves made by clients for groupings of notes;
training a predictive computer model based on values of the plurality of features of the past created modulation curves and groupings of notes;
generating a modulation curve, by applying the predictive computer model to a grouping of notes, that is predicted to best complement that grouping of notes and satisfy the client;
providing a user interface to the client comprising, for each grouping of notes, a generated modulation curve, and a set of parameters for manual adjustments to the modulation curve data.

15. A computer program product comprising a non-transitory computer-readable medium containing computer program code, the computer program code when executed by one or more processors causes the one or more processors to perform operations, the computer program code comprising instructions to:
extract musical note data from a data format via an extraction module, wherein the data format includes one or more of the following types of information: note on, note off, pitch, control change, program change, pitch bend, aftertouch, track data, MIDI data, automation data, grid data, time signature, and key signature;
group the extracted notes together based on temporal relationships and musical appropriateness criteria;
detect any overlapping between the different grouped notes;
split and merge the grouped notes based on temporal relationships between the groupings.

16. The computer program product of claim 15, wherein the data format to be extracted is a MIDI file.

17. The computer program product of claim 15, wherein the temporal relationships and musical appropriateness criteria used are modifiable by the client.

18. The computer program product of claim 15, further comprising instructions to, for each grouping of notes, add modulation curve data.

19. The computer program product of claim 18, further comprising instructions to provide a user interface to the client comprising a set of parameters for manually adding modulation curve data to each grouping of notes.

20. The computer program product of claim 18, further comprising instructions to:
identify a plurality of past created modulation curves made by clients for groupings of notes;
train a predictive computer model based on values of the plurality of features of the past created modulation curves and groupings of notes;
generate a modulation curve, by applying the predictive computer model to a grouping of notes, that is predicted to best complement that grouping of notes and satisfy the client;
provide a user interface to the client comprising, for each grouping of notes, a generated modulation curve, and a set of parameters for manual adjustments to the modulation curve data.
